(19) United States
(12) Patent Application Publication
(10) Pub. No.: US 2025/0338996 A1
(43) Pub. Date: Nov. 6, 2025

(54) Food and Beverage Dispensing Machine With Automatic Cooking Module

(71) Applicant: Munch Industries, Inc, Basking Ridge, NJ (US)

(72) Inventors: Nastassja Kuznetsova, Basking Ridge, NJ (US); Lada Korotaeva, San Francisco, CA (US); Sophia Anzai Takahashi, Boston, MA (US)

(21) Appl. No.: 18/655,059

(22) Filed: May 3, 2024

(51) Int. Cl. A47J 36/32; A47J 27/00

(52) U.S. Cl. CPC A47J 36/32; A47J 27/00

(57) ABSTRACT

An automatic cooking machine is managed by a processor that monitors the current state of each cooker in the machine—i.e., whether a given cooker is empty, is currently being used to cook food, or contains food that has already been prepared—and determines when more of the food item should be prepared. The processor can then instruct the machine to prepare the food by adding water to a cooker, heating the water, monitoring the water temperature, adding the food item to the cooker, and cooking the food item for a desired period of time. If the processor determines that more of the food item should be prepared, then it can instruct the machine to concurrently or sequentially prepare more of the food in a second cooker. The cooking machine may be used to cook perishable boba or tapioca pearls for dispensing in bubble tea.

### FIELD OF THE INVENTION

The present invention generally relates to an automatic cooking machine and, more particularly, an automatic cooking machine to be used as a module in an automated food and/or beverage preparation machine.

### BACKGROUND OF THE INVENTION

The food industry and in particular the fast-food industry is seeing constant growth. In order to keep up with demand and keep labor costs down many attempts are being made to automate the food and beverage preparation process through the use of automated systems.

For example, U.S. Pat. No. 10,595,660 describes a portable fully automatic cooking system which can automatically prepare food items requested by a user. The user selects a recipe file stored in a user interface device and can set a time for that dish to be ready. As another example, CN 114170727 describes automatic milk tea machines and particularly discloses an unmanned retail instant brewing milk tea and fruit beverage machine which comprises a four-axis robot installed on a lower support. A customer may select raw materials to be cooked and then wait while the machine prepares the beverage.

Although a number of automatic cooking machines are available in the market, they are mostly limited to machines that require the user to control when the machine prepares the food or are semi-automatic and require most of the work to be done by the user. Moreover, these machines do not provide for a way in which the cooking process is automatically managed so that there is consistently a fresh supply of the cooked food available. This results in a significant delay of time between when a user puts in an order and when they receive the food or beverage product, particularly if multiple users want to use the machine within a short period of time.

An automatic cooking machine is desired that controls the timing and sequencing of the cooking process across multiple cookers in order to provide a consistent supply of freshly cooked food.

### SUMMARY OF THE INVENTION

The present invention is an automatic cooking machine and method of using the same. The automatic cooking machine includes a container in which the food item will be stored prior to cooking, multiple cookers in which to cook the food item, and a controllable heating element to bring water in the cookers to a boil. The automatic cooking machine is managed by a processor which will monitor the current state of each cooker—i.e., whether a given cooker is empty, is currently being used to cook food, or contains food that has already been prepared. The processor will determine when more of the food item should be prepared and sends out a series of signals to prepare the food by adding water to a cooker, heating the water, monitoring the water temperature, adding the food item to the cooker, and cooking the food item for a desired period of time. If the processor determines that more of the food item should be prepared, then it will send out another series of signals to concurrently or sequentially prepare more of the food item in another cooker. The processor may receive a signal to dispense cooked food from a cooker for consumption by a user of the machine and then send out signals to drain the water from the cooker and dispense the cooked food for consumption. The processor will additionally track the amount of time that has elapsed since the food item in a given cooker was prepared and determine if the food item is still fresh and ready for consumption or should be discarded.

An exemplary embodiment of this invention is an automatic cooking machine used to prepare and cook boba or tapioca pearls. Other examples of food items that may be prepared using this automatic cooking machine include dumplings, rice, and pasta.

The automatic cooking machine of the present invention may be used as a cooking module in tandem with a beverage preparation module to comprise a food and beverage preparation and dispensing machine that creates a combined food and drink item for user consumption. The food and beverage preparation and dispensing machine may additionally contain an ice module to prepare ice to add to the combined food and drink item and a sealing machine to seal the receptacle in which the combined food and drink item has been dispensed. The food and beverage preparation and dispensing machine may be an automatic bubble tea machine that combines tea prepared by the beverage preparation module and boba prepared by the cooking module to create bubble tea.

### BRIEF DESCRIPTION OF DRAWINGS

FIG. 1 shows a food and beverage preparation and dispensing machine according to a sample embodiment.

FIG. 2 shows an automatic cooking machine according to a sample embodiment of the food and beverage preparation and dispensing machine.

FIG. 3A shows a cooker according to a sample embodiment of the automatic cooking machine.

FIG. 3B shows a top-view of the cooker of FIG. 3A.

FIG. 3C shows a bottom-view of the cooker of FIG. 3A.

FIG. 4A shows a dispenser according to a sample embodiment of the automatic cooking machine.

FIG. 4B shows an enclosed central area of the dispenser of FIG. 4A.

FIG. 4C shows a leg of the dispenser of FIG. 4A.

FIG. 5 shows the automatic cooking elements directly controlled by a processor to manage the cooking operation.

FIG. 6 shows a process flow diagram for the management of the automated cooking machine by the processor according to a sample embodiment.

### DETIALED DESCRIPTION

Automatic cooking machines on the market mostly require the user of the machine to initiate the cooking process and can only cook one batch of food at a time. This often results in long wait-times between when a user initiates the cooking process and gets their food, particularly if multiple users wish to use the machine simultaneously or in close succession. Those machines are ill-suited for a grab-and-go customer experience in which the machine preferably has a consistent supply of freshly cooked food prepared so that each customer can quickly place their order and receive their food. The food and beverage preparation and dispensing machine described herein addresses these issues by providing an automatic cooking machine, optionally used as a module in part of an automated food and/or beverage machine, that controls the timing and sequencing of the cooking process across multiple cookers in order to provide a consistent supply of freshly cooked food. The method of managing the automatic cooking machine in order to provide the consistent supply of freshly cooked food is managed by a processor that executes instructions to perform the necessary operations.

Reference is made in detail to embodiments of the invention, which are illustrated in the accompanying drawings. The same reference numbers may be used throughout the drawings to refer to the same or like parts, components, or operations.

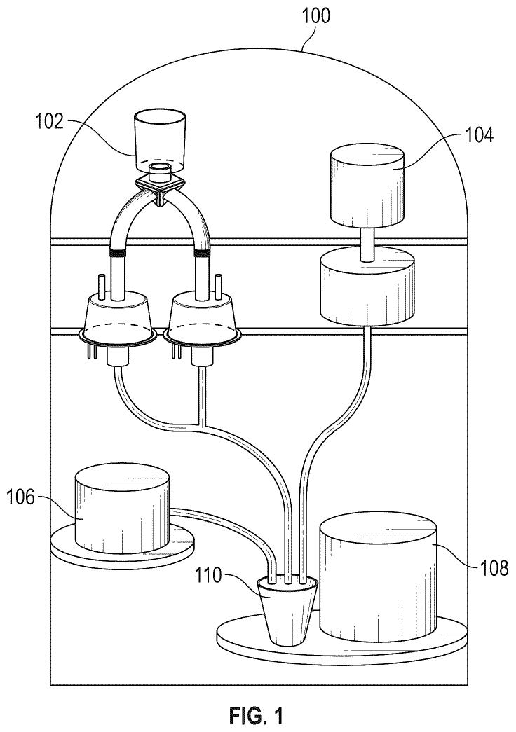

As shown in FIG. 1, the automatic cooking machine 102, in accordance with one embodiment, may be implemented as a cooking module in part of a larger automatic food and beverage preparation and dispensing machine 100. The automatic food and beverage preparation and dispensing machine 100 may additionally include a beverage preparation module 104, an ice module 106, and/or a sealing machine 108. The food prepared by the cooking module 102 may be added to a drink prepared by the beverage preparation module 104 and/or ice from the ice module 106 to create a combined food and drink product. The sealing machine 108 may be used to seal a prepared food, beverage, or combined food and drink product in a receptacle 110.

In one embodiment, the automatic food and beverage preparation and dispensing machine 100 may be an automated bubble tea machine which combines tea prepared by the beverage preparation module 104 with boba or tapioca pearls cooked and prepared by the cooking module 102 to create bubble tea.

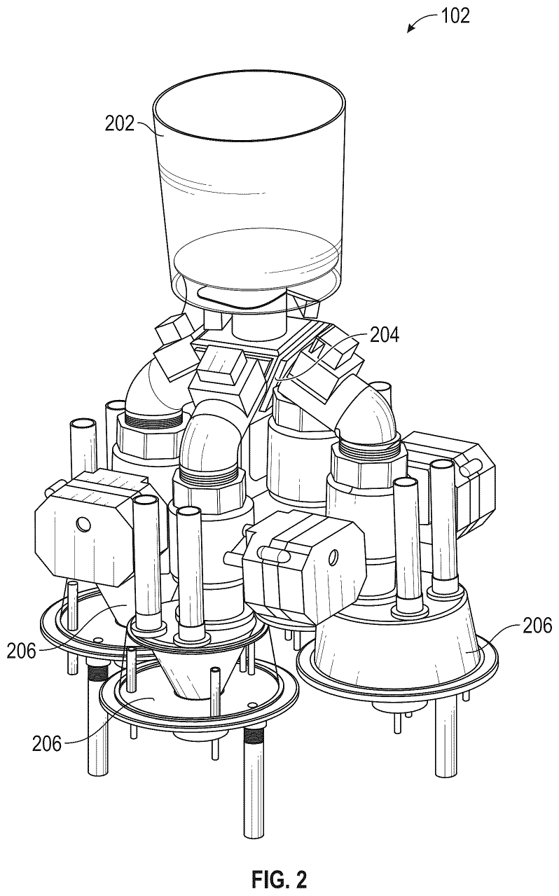

As shown in FIG. 2, the automatic cooking machine 102 comprises a food item storage container 202, a dispenser 204, and at least two cookers 206. The dispenser 204 is arranged to receive a quantity of the uncooked food item from the food item storage container 202 and distribute a desired quantity of the uncooked food item to each cooker 206.

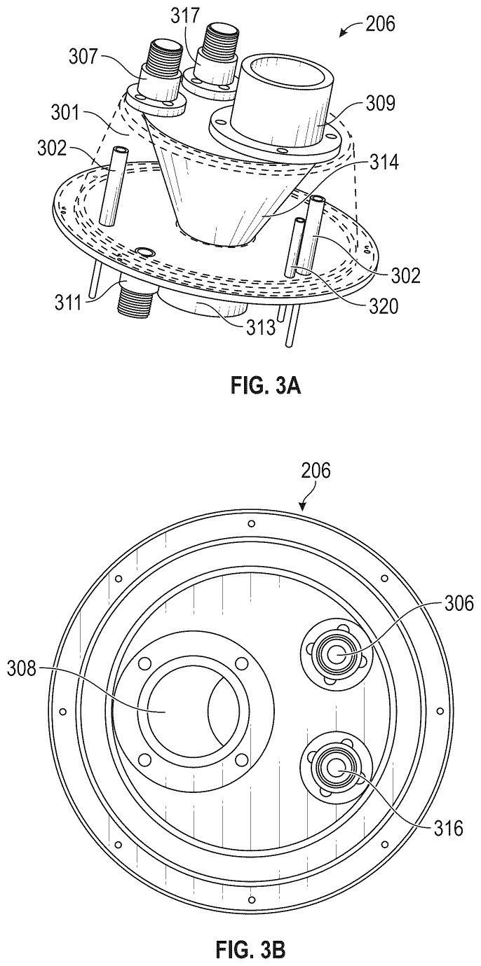

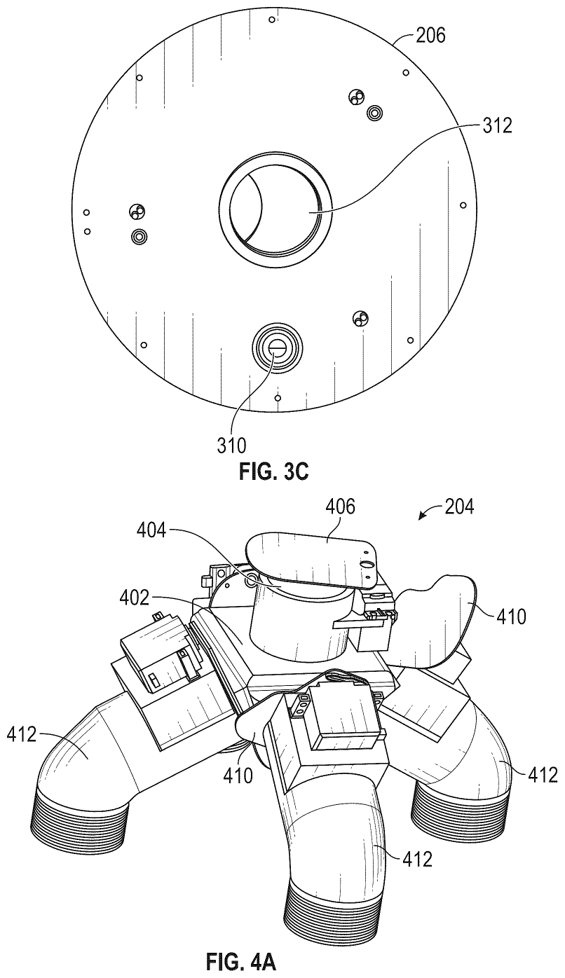

As shown in FIGS. 3A-3C, each cooker 206 comprises one or more controllable heating elements 302 that are used to bring the water in the cooker 206 to a boil and maintain a desired water temperature during the cooking process. In the embodiment of FIG. 3, the controllable heating element 302 comprises cartridge heaters located inside of the cooker 206 and immersed in water in an enclosed area 301 of the cooker 206. Each cooker 206 further includes a first inlet aperture 306 operably sealed by a controllable valve 307 through which water can enter the enclosed area 301 of the cooker 206, a second inlet aperture 308 operably sealed by a controllable valve 309 through which the uncooked food item can enter the enclosed area 301 of the cooker 206, a first outlet aperture 310 operably sealed by a controllable valve 311 through which water can be drained from the enclosed area 301 of the cooker 206, and a second outlet aperture 312 operably sealed by a controllable valve 313 through which the prepared food item can be dispensed from the enclosed area 301 of the cooker 206. A strainer 314 may be positioned inside the enclosed area 301 of the cooker 206 to funnel the food item to the second outlet aperture 312 for dispensing the prepared food item. In addition, the cooker 206 may comprise a third outlet aperture 316 operably sealed by a controllable valve 317 through which steam can escape from the enclosed area 301 during the cooking process. One or more temperature sensors 320 may be arranged to measure the temperature of water in the cooker 206 during the cooking process.

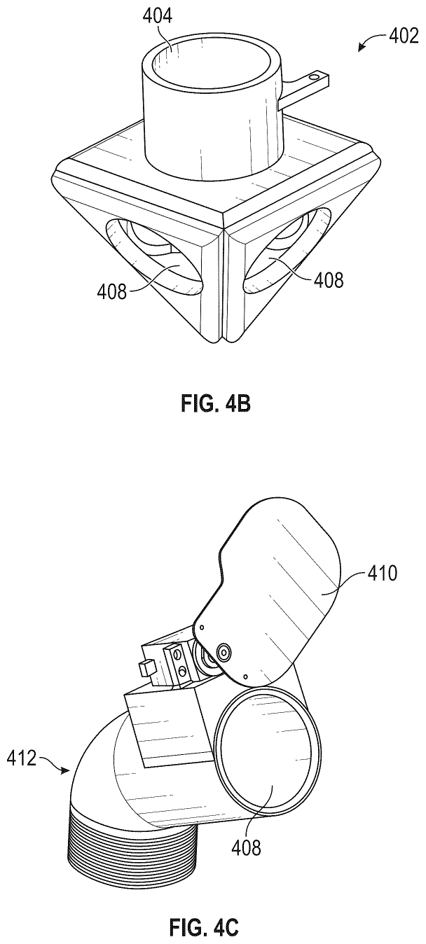

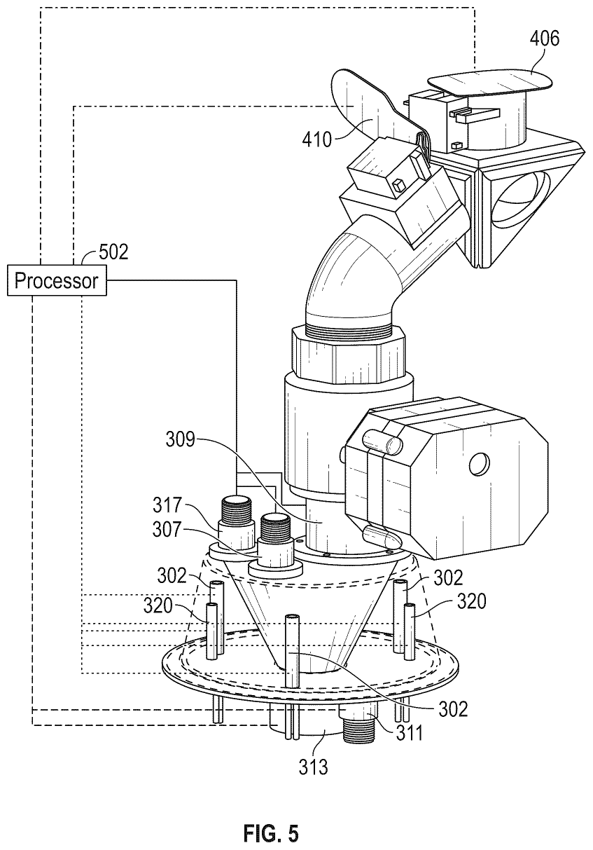

As shown in FIGS. 4A-4C, the dispenser 204 comprises an enclosed central area 402, an inlet aperture 404 which is operably covered by a controllable divider 406 that can be opened to allow a quantity of the uncooked food item to enter the enclosed central area 402 of the dispenser 204 from the food item storage container 202, and a number of legs 412 and outlet apertures 408 equal to the number of cookers 206 in the automatic cooking machine 102. Each outlet aperture 408 is operably covered by a controllable divider 410 that can be opened to allow the quantity of the uncooked food item in the dispenser 204 to be dispensed into one of the cookers 206 through one of the legs 412. In one embodiment, the quantity of the food item is predetermined based on the capacity of the enclosed central area 402. The predetermined quantity of the food item prepared may be portioned to be a single serving of the food item or multiple servings of the food item. Multiple servings may be dispensed separately from a cooker 206 via operation of the controllable valve 313 operably sealing the second outlet aperture 312 through which the prepared food item is dispensed from the enclosed area 301 of the cooker 206. Which cooker 206 is to receive the uncooked food item is determined by the processor 502 (see FIG. 5) through control of the appropriate controllable divider 410.

FIG. 5 shows the various components of the automatic cooking machine 102 that the processor 502 sends signals to in order to manage the operations of the automatic cooking machine 102. The processor 502 operably controls the controllable heating element 302 to raise the temperature of the water inside the enclosed areas 301 of the cookers 206. Additionally, the processor 502 actuates the various controllable valves 307, 309, 311, 313, and 317 and controllable dividers 406 and 410 in order to add water to the enclosed areas 301 of the cookers 206, dispense water from the enclosed areas 301 of the cookers 206, dispense the uncooked food item from the food item storage container 202 into the dispenser 204, dispense the uncooked food item from the dispenser 204 into the enclosed areas 301 of the cookers 206, and dispense the prepared food item from the enclosed areas 301 of the cookers 206. The processor 502 also receives information from temperature sensors 320 in order to manage the operations of the automatic cooking machine 102.

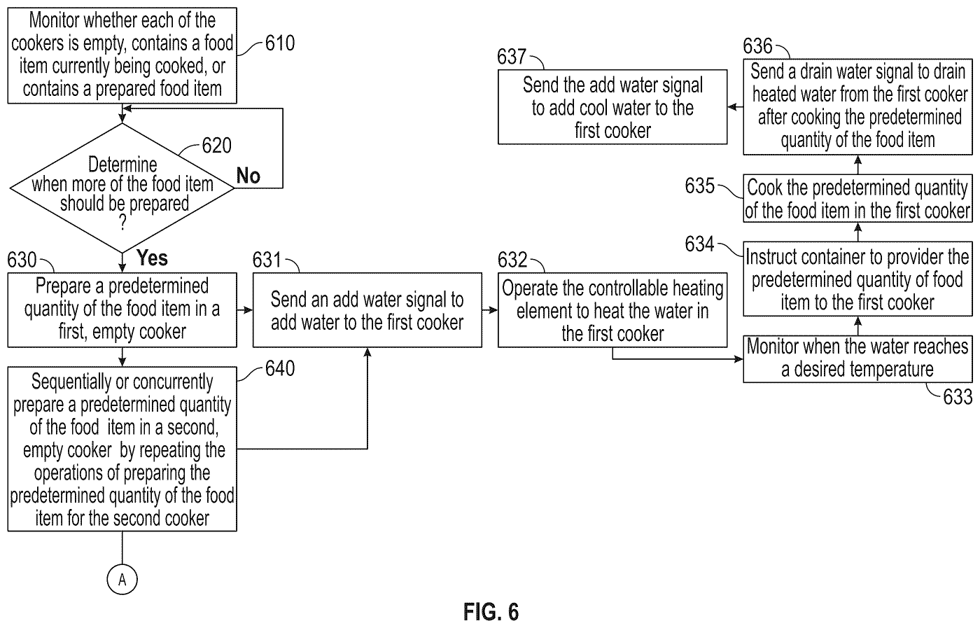

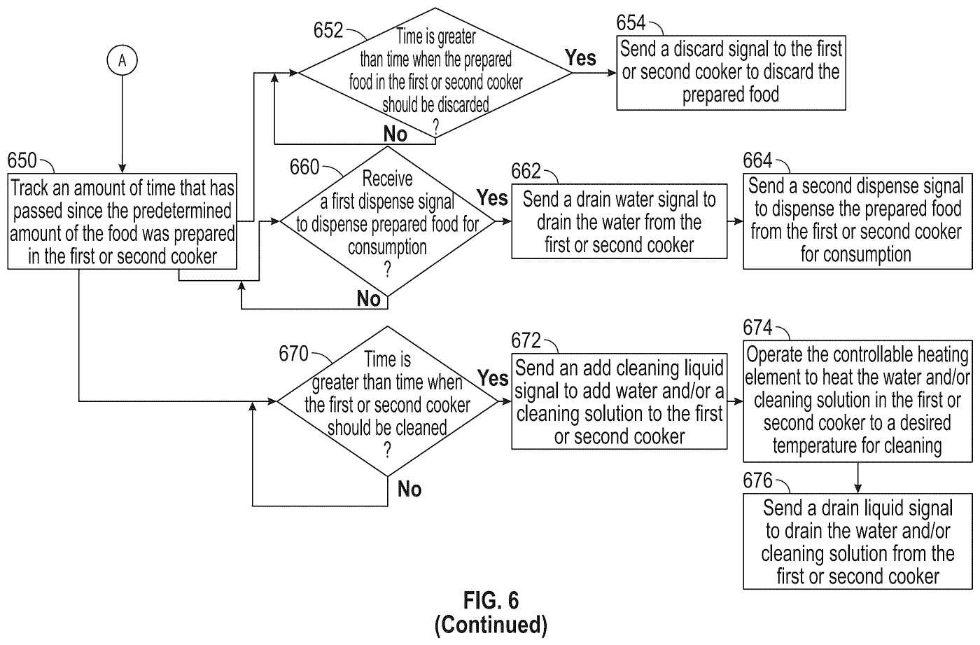

FIG. 6 illustrates a process flow diagram for the management of the automated cooking machine 102 by the processor 502 according to a sample embodiment. The processor 502 manages the automated cooking machine 102 in order to provide a consistent supply of freshly cooked food by executing instructions to perform the indicated operations. First, the processor 502 constantly monitors whether each cooker 206 is currently empty, contains a food item currently being cooked, or contains a prepared food item (610). For example, the processor 502 may set a flag when a cooker 206 contains a food item and clear the flag when the cooker 206 is emptied. The processor 502 also determines when more of the food item should be prepared (620). For example, if a user has operated the automatic cooking machine 102 and requested a cooked food item but none are currently available, the processor 502 will receive a request to prepare a food item. In one embodiment, the processor 502 determines when more of the food item should be prepared by comparing the amount of the food that is currently prepared against a desired threshold. The desired threshold could be set or the processor 502 could adjust the desired threshold based on expected usage of the automated cooking machine 102 during different times of the day or the week, etc.

Upon determining that more of the food should be prepared, the processor 502 manages the preparation of a predetermined quantity of the food item in a first, empty cooker 206 (630). The processor 502 will do so by sending an add water signal to add water to the first cooker 206 (631), operating the controllable heating element 302 to heat the water in the first cooker 206 (632), monitoring when the water reaches a desired temperature (633), instructing the food item storage container 202 to provide the predetermined quantity of uncooked food item to the first cooker 206 (634), and cooking the predetermined quantity of the food item in the first cooker 206 for a desired time (635). After the predetermined quantity of the food item is finished cooking (e.g., a predetermined amount of time has passed), the processor 502 may send a drain water signal to drain the heated water from the first cooker 206 (636) and send the add water signal to add cool water to the first cooker 206 (637). In one embodiment the processor 502 monitors when the water in a first cooker 206 reaches a desired temperature (633) by receiving information from a temperature sensor 320 positioned inside the first cooker 206. In the sample embodiment of FIG. 6, the processor 502 instructs the food item storage container 202 to provide the predetermined quantity of uncooked food item to the first cooker 206 (634) by operating a first controllable divider 406 positioned between the food item storage container 202 and the dispenser 204 to allow the predetermined quantity of the uncooked food item to fall into the dispenser 204 and then operating a second controllable divider 410 positioned between the dispenser 204 and the first cooker 206 to allow the predetermined quantity of the uncooked food item to fall into the first cooker 206.

Sequentially or concurrently with the preparation of a predetermined quantity of the food item in a first, empty cooker 206 (630), the processor 502 may manage the preparation of a predetermined quantity of the food item in a second, empty cooker 206 (640). To do so, the processor 502 will repeat the same steps it took to manage the preparation in the first cooker 206 (631-637) for the second cooker 206. The processor 502 will determine whether to initiate the preparation of a predetermined quantity of the food item in a second, empty cooker 206 (640) based on its determination of when more of the food item should be prepared (620). For example, if the processor 502 has received a request to prepare an amount of the food item but the requested amount of food exceeds the amount of food the first cooker 206 can prepare, then the processor 502 will initiate the preparation of a predetermined quantity of the food item in a second, empty cooker 206 (640). In the embodiment in which the processor 502 determines when more of the food item should be prepared by comparing the amount of the food that is currently prepared against a desired threshold, the processor 502 will initiate the preparation of a predetermined quantity of the food item in a second, empty cooker 206 (640) if the amount of food that can be prepared by the first cooker 206 added to the amount of the food that is currently prepared would not exceed the desired threshold.

In the sample embodiment of FIG. 6, after the predetermined quantity of food has been prepared in a cooker 206, the processor 502 will track the amount of time that has passed (650). Then, the processor 502 will determine when the prepared food in the cooker 206 should be discarded (652). Upon a determination that too much time has elapsed and the prepared food is no longer fresh, the processor 502 will send a discard signal to the cooker 206 to discard the prepared food (654).

The processor 502 is further configured to receive a first dispense signal to dispense the prepared food for consumption when a user inputs a request for the food item (660). Upon receiving the first dispense signal to dispense the prepared food item for consumption (660), the processor 502 will send a drain water signal to drain the water from a cooker 206 with prepared food in it (662) and then send a second dispense signal to dispense the prepared food item from the cooker for consumption by the user (664).

Additionally, the processor 502 may be configured to determine when a cooker 206 should be cleaned (670). In one embodiment, the processor 502 may determine when a cooker 206 should be cleaned (670) by tracking an amount of time that has passed since the cooker 206 was last cleaned and comparing that amount of time against a desired length of time. In another embodiment the processor 502 may determine when a cooker 206 should be cleaned (670) by using a sensor to detect how dirty the cooker 206 is. The determination may further be based on the frequency of usage of the automatic cooking machine 102. For example, if a cooker 206 is used more frequently, then the processor 502 will reach a determination to clean the cooker 206 more often. Additionally or alternatively, the processor 502 may determine to clean the cooker 206 at known times of less frequent usage (e.g., at night).

Upon a determination that a cooker 206 should be cleaned and that the cooker 206 is empty, the processor 502 will clean the cooker 206 by sending an add cleaning liquid signal to add water and/or a cleaning solution to the first or second cooker 206 (672), operating the controllable heating element 302 to heat the water and/or cleaning solution in the cooker 206 to a desired temperature for cleaning (674), and sending a drain cleaning liquid signal to drain the water and/or cleaning solution from the cooker 206 (676). In one embodiment the cleaning solution may be housed in a separate container that is operably connected to the water line leading to the first inlet aperture 306 through which water can enter the enclosed area 301 of the cooker 206 in order to allow for the water and/or cleaning solution used to clean the cooker 206 to enter the cooker 206.

In an exemplary embodiment, the processor 502 will manage the automatic cooking machine 102, which shall be one module within an automated food and beverage preparation and dispensing machine 100, in order to provide a consistent supply of fresh boba that may be combined with tea prepared by a beverage preparation module 104 of the automated food and beverage preparation and dispensing machine 100 to create a bubble tea drink upon receipt of a customer's order. The preparation of the tea by the beverage preparation module 104 may be controlled by the same processor 502 that controls the automatic cooking machine 102 or by a different processor not shown in the accompanying drawings. Likewise, the same processor 502 that controls the automatic cooking machine 102 or different processors not shown in the accompanying drawings may control other operations of the automated food and beverage preparation and dispensing machine 100 including the payment process for a user of the automated food and beverage preparation and dispensing machine 100, the preparation and dispensing of ice from the ice module 106, and the sealing of a prepared food, beverage, or combined food and drink product in a receptacle 110 by a sealing machine 108.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.”

The term “and/or” may comprise any and all combinations of one or more of the associated listed items. In addition, the singular forms “a,” “an,” and “the” herein are intended to comprise the plural forms as well, unless the context clearly indicates otherwise.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed, but that the disclosure will include all embodiments falling within the scope of the appended claims.

1. A method for managing an automated cooking and food preparation machine that includes a container, at least two cookers, a controllable heating element, and a processor, the method comprising:
storing a food item in the container;
monitoring, by the processor, whether each of the at least two cookers is empty, contains a food item currently being cooked, or contains a prepared food item;
determining, by the processor, when more of the food item should be prepared;
in response to a determination that more of the food item should be prepared, preparing a predetermined quantity of the food item in a first cooker by:
sending, by the processor, an add water signal to add water to the first cooker;
operating the controllable heating element to heat the water in the first cooker;
monitoring, by the processor, when the water in the first cooker has reached a desired temperature;
instructing, by the processor, the container to provide the predetermined quantity of the food item to the first cooker; and
cooking the predetermined quantity of the food item in the first cooker; and
in response to a determination that more of the food item should be prepared, sequentially or concurrently preparing more of the food item in a second cooker by repeating the operations of preparing the predetermined quantity of the food item for the second cooker.

2. The method according to claim 1, wherein determining when more of the food item should be prepared comprises:
comparing an amount of the food item that is currently prepared against a desired threshold.

3. The method according to claim 1, wherein instructing the container to provide the predetermined quantity of the food item to the first or second cooker comprises:
operating a first controllable divider positioned between the container and a dispenser to allow the predetermined quantity of the food item to fall into the dispenser; and
operating a second controllable divider positioned between the dispenser and the first or second cooker to allow the predetermined quantity of the food item to fall into the first or second cooker.

4. The method according to claim 1, wherein sending the add water signal to the first or second cooker comprises:
operating a controllable valve positioned between a water source and the first or second cooker.

5. The method according to claim 1, further comprising:
receiving, by the processor, a first dispense signal to dispense prepared food for consumption;
sending, by the processor, a drain water signal to drain the water from the first or second cooker; and
sending, by the processor, a second dispense signal to dispense the prepared food from the first or second cooker for consumption.

6. The method according to claim 1, further comprising:
tracking, by the processor, an amount of time that has passed since the predetermined amount of food was prepared in the first or second cooker;
determining, by the processor, when the prepared food in the first or second cooker should be discarded; and
sending, by the processor, a discard signal to the first or second cooker to discard the prepared food.

7. The method of claim 1, further comprising:
sending, by the processor, a drain water signal to drain heated water from the first or second cooker after cooking the predetermined quantity of the food item; and
sending, by the processor, the add water signal to add cool water to the first or second cooker from which the heated water has been drained.

8. The method of claim 1, further comprising:
determining, by the processor, when the first or second cooker should be cleaned;
in response to a determination that the first or second cooker should be cleaned and that the first or second cooker is empty, cleaning the first or second cooker by:
sending, by the processor, an add cleaning liquid signal to add at least one of water or a cleaning solution to the first or second cooker;
operating the controllable heating element to heat the at least one of water or cleaning solution in the first or second cooker to a desired temperature for cleaning; and
sending, by the processor, a drain cleaning liquid signal to drain the at least one of water or cleaning solution from the first or second cooker.

9. An automatic cooking machine comprising:
a food item storage container;
at least two cookers arranged to receive a predetermined quantity of the food item from the food item storage container;
a controllable heating element; and
a processor that executes instructions to perform operations, those operations including:
monitoring whether each of the at least two cookers is empty, contains a food item currently being cooked, or contains a prepared food item;
determining when more of the food item should be prepared;
in response to a determination that more of the food item should be prepared, preparing a predetermined quantity of the food item in a first cooker by:
sending an add water signal to add water to the first cooker;
operating the controllable heating element to heat the water in the first cooker;
monitoring when the water in the first cooker has reached a desired temperature;
instructing the container to provide the predetermined quantity of the food item to the first cooker; and
cooking the predetermined quantity of the food item in the first cooker; and
in response to a determination that more of the food item should be prepared, sequentially or concurrently preparing more of the food item in a second cooker by repeating the operations of preparing the predetermined quantity of the food item for the second cooker.

10. The automatic cooking machine of claim 9, wherein the processor executes further instructions to perform further operations including:
receiving a first dispense signal to dispense prepared food for consumption;
sending a drain water signal to drain the water from the first or second cooker; and
sending a second dispense signal to dispense the prepared food from the first or second cooker for consumption.

11. The automatic cooking machine of claim 9, wherein the processor executes further instructions to perform further operations including:
tracking an amount of time that has passed since the predetermined amount of food was prepared in the first or second cooker;
determining when the prepared food in the first or second cooker should be discarded; and
sending a discard signal to the first or second cooker to discard the prepared food.

12. The automatic cooking machine of claim 9, wherein the processor executes further instructions to perform further operations including:
determining when the first or second cooker should be cleaned;
in response to a determination that the first or second cooker should be cleaned and that the first or second cooker is empty, cleaning the first or second cooker by:
sending an add cleaning liquid signal to add at least one of water or a cleaning solution to the first or second cooker;
operating the controllable heating element to heat the at least one of water or cleaning solution in the first or second cooker to a desired temperature for cleaning; and
sending a drain cleaning liquid signal to drain the at least one of water or cleaning solution from the first or second cooker.

13. The automatic cooking machine of claim 9, wherein each of the at least two cookers comprises:
a first inlet aperture sealed by a first controllable valve from which water can be received;
a second inlet aperture sealed by a controllable divider from which the food item can be received;
a first outlet aperture sealed by a second controllable valve through which water can be drained;
a second outlet aperture sealed by a third controllable valve through which the predetermined quantity of the food item can be dispensed or discarded;
a third outlet aperture sealed by a fourth controllable valve through which steam can escape; and
a strainer positioned to funnel the predetermined quantity of the food item to the second outlet aperture.

14. The automatic cooking machine of claim 9 further comprising a dispenser arranged to receive the predetermined quantity of the food item from the food item storage container, wherein the dispenser comprises:
an inlet aperture operably covered by a first controllable divider;
an enclosed central area; and
a number of outlet apertures equal to a number of cookers, the outlet apertures operably covered by second controllable dividers.

15. The automatic cooking machine of claim 9, wherein the heating element comprises at least one cartridge heater immersed in each of the at least two cookers.

16. The automatic cooking machine of claim 9, wherein the food item is boba or tapioca pearls.

17. An automatic food and beverage preparation and dispensing machine comprising:
a beverage preparation module that prepares and mixes a beverage component; and
a cooking module comprising:
a food item storage container;
at least two cookers arranged to receive a predetermined quantity of the food item from the food item storage container;
a controllable heating element; and
a processor that executes instructions to perform operations, those operations including:
monitoring whether each of the at least two cookers is empty, contains a food item currently being cooked, or contains a prepared food item;
determining when more of the food item should be prepared;
in response to a determination that more of the food item should be prepared, preparing a predetermined quantity of the food item in a first cooker by:
sending an add water signal to add water to the first cooker;
operating the controllable heating element to heat the water in the first cooker;
monitoring when the water in the first cooker has reached a desired temperature;
instructing the container to provide the predetermined quantity of the food item to the first cooker; and
cooking the predetermined quantity of the food item in the first cooker;
in response to a determination that more of the food item should be prepared, sequentially or concurrently preparing more of the food item in a second cooker by repeating the operations of preparing the predetermined quantity of the food item for the second cooker; and
adding a desired amount of the prepared food item to the beverage component.

18. The automatic food and beverage preparation and dispensing machine of claim 17, wherein the processor executes further instructions to perform further operations including:
receiving a first dispense signal to dispense prepared food for consumption;
sending a drain water signal to drain the water from the first or second cooker; and
sending a second dispense signal to dispense the prepared food from the first or second cooker for consumption.

19. The automatic food and beverage preparation and dispensing machine of claim 17, wherein the processor executes further instructions to perform further operations including:
tracking an amount of time that has passed since the predetermined amount of food was prepared in the first or second cooker;
determining when the prepared food should be discarded; and
sending a discard signal to the first or second cooker to discard the prepared food.

20. The automatic food and beverage preparation and dispensing machine of claim 17, wherein the processor executes further instructions to perform further operations including:
determining when the first or second cooker should be cleaned;
in response to a determination that the first or second cooker should be cleaned and that the first or second cooker is empty, cleaning the first or second cooker by:
sending an add cleaning liquid signal to add at least one of water or a cleaning solution to the first or second cooker;
operating the controllable heating element to heat the at least one of water or cleaning solution in the first or second cooker to a desired temperature for cleaning; and
sending a drain cleaning liquid signal to drain the at least one of water or cleaning solution from the first or second cooker.

21. The automatic food and beverage preparation and dispensing machine of claim 17, wherein the each of the at least two cookers comprise:
a first inlet aperture sealed by a first controllable valve from which water can be received;
a second inlet aperture sealed by a controllable divider from which the food item can be received;
a first outlet aperture sealed by a second controllable valve through which water can be drained;
a second outlet aperture sealed by a third controllable valve through which the predetermined quantity of the food item can be dispensed or discarded;
a third outlet aperture sealed by a fourth controllable valve through which steam can escape; and
a strainer positioned to funnel the predetermined quantity of the food item to the second outlet aperture.

22. The automatic food and beverage preparation and dispensing machine of claim 17, wherein the cooking module further comprises a dispenser arranged to receive the predetermined quantity of the food item from the food item storage container, said dispenser comprising:
an inlet aperture operably covered by a first controllable divider;
an enclosed central area; and
a number of outlet apertures equal to a number of cookers, the outlet apertures operably covered by second controllable dividers.

23. The automatic food and beverage preparation and dispensing machine of claim 17, wherein the food item is boba or tapioca pearls and the beverage component is tea.
